(19) United States
(12) Patent Application Publication
(10) Pub. No.: US 2006/0196318 A1
(43) Pub. Date: Sep. 7, 2006

(54) Wrench with end stopper arrangement

(76) Inventor: Chung Hsing Teng, Taichung Hsien (TW)

Correspondence Address: Raymond Y. Chan, 108 N. Ynez Ave., #128, Monterey Park, CA, 91754, US

(21) Appl. No.: 11/071,637

(22) Filed: Mar. 2, 2005

(51) Int. Cl. B25B 13/06; B25B 13/02

(52) U.S. Cl. 81/125; 81/121.1

(57) ABSTRACT

A wrench includes a wrench body and an end stopper arrangement. The end stopper arrangement includes a turning head extended at a handle portion of the wrench body, wherein the turning head has a through turning cavity and a plurality of gripping muscles spacedly and inwardly protruded from a sidewall of the turning cavity for engaging with the corner portions of a bolt nut, and a plurality of blocking members integrally and inwardly protruded from each of the gripping muscles to partially cover an opening of the turning cavity such that when the bolt nut is inserted into the turning cavity to engage with the gripping muscles, the blocking members are adapted for biasing against a top side of the bolt nut for ensuring that the bolt nut is fittedly retained in the turning cavity without dislodgment of the wrench body.

### BACKGROUND OF THE PRESENT INVENTION

1. Field of Invention

The present invention relates to a wrench, and more particularly to a wrench comprising an end stopper arrangement which is capable of preventing the wrench from dislodging or slipping during turning of a nut bolt.

2. Description of Related Arts

A conventional wrench usually comprises a handle and a turning head integrally formed at an end portion of the handle to define a through bolt receiving cavity, and a plurality of gripping jaws radially extended from a sidewall of the bolt receiving cavity for gripping on a bolt nut which is to be turned by the wrench.

As a matter of conventional art, each wrench is specifically designed to turn a bolt nut of a predetermined size. For example, the size of the receiving cavity may be designed and crafted to allow a bolt nut of a predetermined size to be fittedly received therein, wherein the gripping jaws are engaged with an outer surface of the bolt nut for turning thereof.

A common problem of this kind of conventional wrench is that when a user is turning a bolt nut, the wrench may dislodge or slip from the bolt nut so that the gripping jaws and the bolt nut are disengaged with each other. Since the receiving cavity of the turning head is through and open at a top and a bottom side of the turning head, it is very difficult for a user to retain it in position (keep engaging with the relevant bolt nut) during turning of the wrench, especially when he/she is working in confined space or non-conventional environment.

The situation is even worse when the wrench is being used in an upside down manner wherein the bolt and the bolt nut are required to be threaded in an upward direction. In such a situation, it is very difficult for the user to maintain fit engagement between the nut bolt and the gripping jaws of the wrench.

At an attempt to resolve the above-mentioned problem, several improvements have been made. First, there exists a wrench which comprises a retaining washer disposed in the receiving cavity for closing a top opening thereof so as to prevent a bolt nut from penetrating through the receiving cavity when it is being turned by the wrench.

A main problem for this is that although the retaining washer is effective in preventing slipping or dislodgement of the wrench, it significantly curtails the flexibility of the wrench as a whole. Moreover, by disposing the retaining washer within the receiving cavity, the surface area of the gripping jaws which are arranged to engage with the bolt nut is substantially reduced as compared with the above-mentioned wrench. The consequence is that when a user is using the wrench for turning a bolt nut, he/she has to use greater amount of force to achieve what would be the same performance as the wrench without the retaining washer.

Second, in order to add anything at the receiving cavity for preventing the slipping or the dislodging movement of the wrench, the manufacturing cost of that wrench would inevitably increase. This is wholly inconsistent with the traditional conception that wrench should be an economical and convenient hand tool for turning a nut bolt. In the case where a retaining washer is integrally provided within the receiving cavity, traditional manufacturing methods such as injection molding may not be satisfactory for manufacturing such a wrench.

### SUMMARY OF THE PRESENT INVENTION

A main object of the present invention is to provide a wrench comprising an end stopper arrangement which is capable of preventing the wrench from dislodging or slipping during turning of a nut bolt.

Another object of the present invention is to provide a wrench comprising an end stopper arrangement which comprises a plurality of blocking members integrally extended from a sidewall of a turning cavity to partially cover a corresponding opening thereof so as to ensure that a bolt nut is fittedly retained within a turning cavity for preventing dislodgement of the wrench.

Another object of the present invention is to provide a wrench with an end stopper arrangement, wherein the wrench is capable of turning bolt nuts with various sizes.

Another object of the present invention is to provide a wrench comprising an end stopper arrangement which is easy to manufacture so as minimize the manufacturing cost of the present invention.

Accordingly, in order to accomplish the above objects, the present invention provides a wrench for turning a bolt nut having a polygon cross section defining a plurality of corner portions between each two adjacent side surfaces, comprising:

a wrench body having an elongated handle portion; and

an end stopper arrangement, which comprises:

a turning head integrally extended at the handle portion of the wrench body, wherein the turning head has a through turning cavity and a plurality of gripping muscles spacedly and inwardly protruded from a sidewall of the turning cavity for engaging with the corner portions of the bolt nut; and

a plurality of blocking members integrally and inwardly protruded from each of the gripping muscles to partially cover an opening of the turning cavity such that when the bolt nut is inserted into the turning cavity to engage with the gripping muscles, the blocking members are adapted for biasing against a top side of the bolt nut for ensuring that the bolt nut is fittedly retained in the turning cavity without dislodgment of the wrench body.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a wrench according to a preferred embodiment of the present invention.

FIG. 2 is a sectional side view of the wrench according to the above preferred embodiment of the present invention.

FIG. 3A and FIG. 3B are the first alternative mode of the wrench according to the above preferred embodiment of the present invention, illustrating that a sectional side view and a bottom view of the wrench respectively.

FIG. 4A and FIG. 4B are the second alternative mode of the wrench according to the above preferred embodiment of the present invention, illustrating that a sectional side view and a bottom view of the wrench respectively.

FIG. 5 is a third alternative mode of the wrench according to the above preferred embodiment of the present invention.

FIG. 6 is a fourth alternative mode of the wrench according to the above preferred embodiment of the present invention.

### DETAILED DESCRIPTION OF THE PREFERRED EMBODIMENT

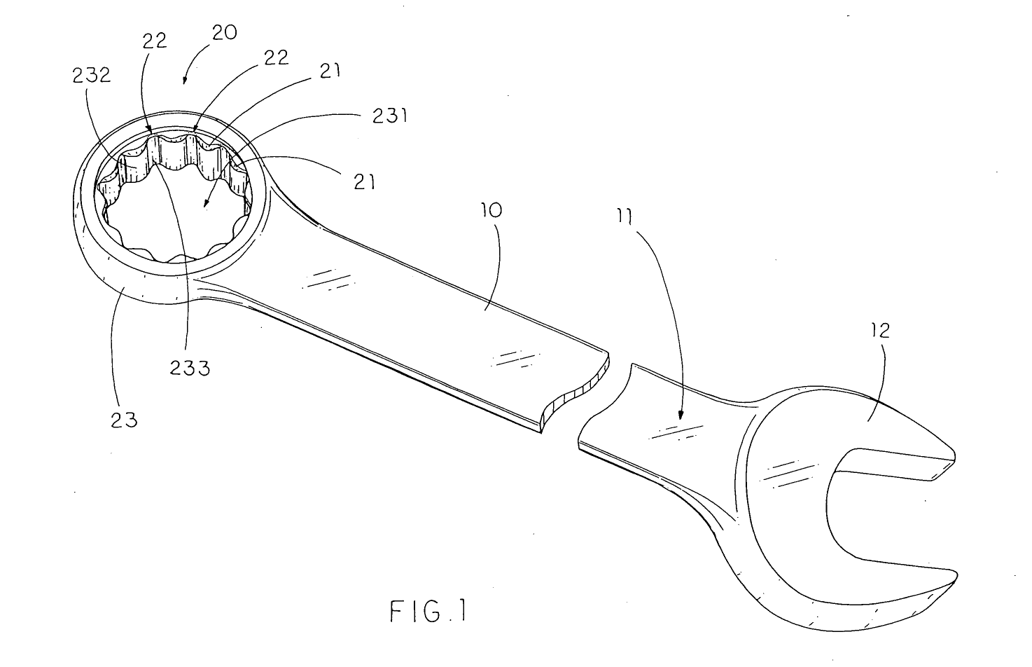

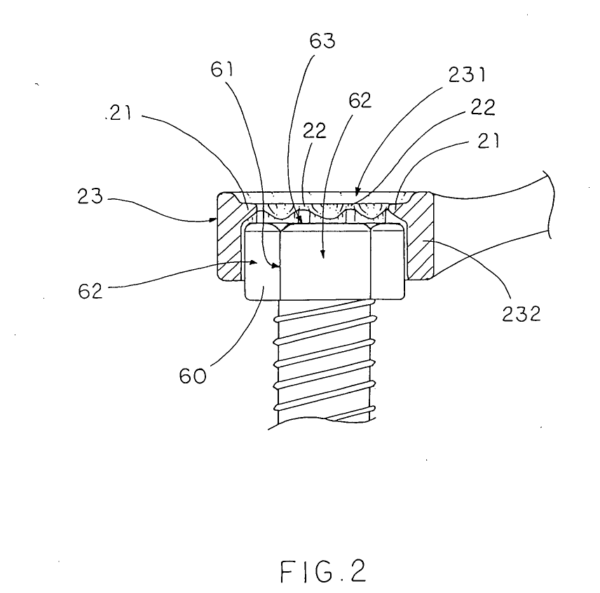

Referring to FIG. 1 and FIG. 2 of the drawings, a wrench for turning a bolt nut 60 having a polygon cross section defining a plurality of corner portions 61 between each two adjacent side surfaces 62 is illustrated. According to the preferred embodiment of the present invention, the wrench comprises a wrench body 10 and an end stopper arrangement 20.

The wrench body 10 has an elongated handle portion 11, a nut head 12, and an opposed turning head 23 integrally extended at the handle portion 11 of the wrench body 10, wherein the turning head 23 has a through turning cavity 231 and a plurality of gripping muscles 232 spacedly and inwardly protruded from a sidewall 233 of the turning cavity 231 for engaging with the corner portions 61 of the bolt nut 60.

The end stopper arrangement 20 comprises a plurality of blocking members 21 integrally and inwardly protruded from each of the gripping muscles 232 to partially cover an opening of the turning cavity 231 such that when the bolt nut 60 is inserted into the turning cavity 231 to engage with the gripping muscles 232, the blocking members 21 are adapted for biasing against a top side 63 of the bolt nut 60 for ensuring that the bolt nut 60 is fittedly retained in the turning cavity 231 without dislodgment of the wrench body 10.

According to the preferred embodiment of the present invention, the wrench is preferably adapted for turning a bolt nut 60 having a hexagonal cross section. Thus, the bolt nut 60 has six side surfaces 62 defining six corner portions 61 between each two adjacent side surfaces 62.

Each of the blocking members 21 is integrally and inwardly protruded from a top edge portion of the respective gripping muscle 232 so as to partially cover a top opening of the turning cavity 231 so that the turning head 23 is still capable of fittedly engaging with a substantial portion of the bolt nut 60 while preventing dislodgment of the bolt nut 60 from the wrench. In other words, the end stopper arrangement 20 of the present invention does not interfere with the operation of the turning head 23.

Referring to FIG. 1 of the drawings, the end stopper arrangement 20 further comprises a plurality of reinforcing ribs 22 integrally and slightly protruded from the sidewall 233 of the turning cavity 231 between each two adjacent blocking muscles 21 for reinforcing a blocking effect of the blocking members 21. It is worth mentioning that when the turning head 23 is driven to turn the bolt nut 60, the reinforcing ribs 22 is capable of evenly distributing stress along the end stopper arrangement 20 so as to ensure fit engagement between the bolt nut 60 and the turning head 23 for further preventing dislodgment of the bolt nut 60 from the wrench when substantial force is applied (to turn the bolt nut 60).

As a result, one may appreciate that a diameter of the top opening of the turning cavity 231 as partially covered by the blocking members 21 is slightly smaller than that of a bottom opening of the turning cavity 231 so that the bolt nut 60, having a size corresponding with that of the turning cavity 231, is capable of inserting therein via the bottom opening to engage with the gripping muscles 232 while being blocked by the blocking members 21 for preventing dislodgement.

When the wrench is utilized to screw down the bolt nut 60 or to unscrew the bolt nut 60 in an upward direction, the user simply needs to, apart from applying a torque for turning the elongated handle portion 11, apply a small downward force at the bolt nut 60 so as to keep it biasing against the blocking members 21 so that when the bolt nut 60 is being turned, the turning head 23 is prevented from dislodging while the bolt nut 60 is kept fittedly engaging with the gripping muscles 232.

Conversely, when the wrench is utilized in an upside down manner, in order to screw up the bolt nut 60 or to unscrew it in a downward direction, the user simply needs to, apart from applying a torque for turning the elongated handle portion 11, apply a small upward force at the bolt nut 60 so as to keep it biasing against the blocking members 21 so that when the bolt nut 60 is being turned, the turning head 23 is prevented from dislodging while the bolt nut 60 is kept fittedly engaging with the gripping muscles 232.

The manufacturing method of the present invention is simple: the wrench may be fabricated by a conventional injection molding process for forming the wrench body 10. After that, the turning head 23 is pressed, preferably by a pressing machine, at the top opening of the turning cavity 231 on the gripping muscles 232 so as to form the blocking members 21 and the reinforcing ribs 22. Typically, the entire wrench will be subject to hardening process for enhancing a surface hardness of the wrench. In other words, according to the preferred embodiment, the present invention does not require changes to conventional wrench's manufacturing process. What is required is to subject the wrench to pressing so as to form the end stopper arrangement 20.

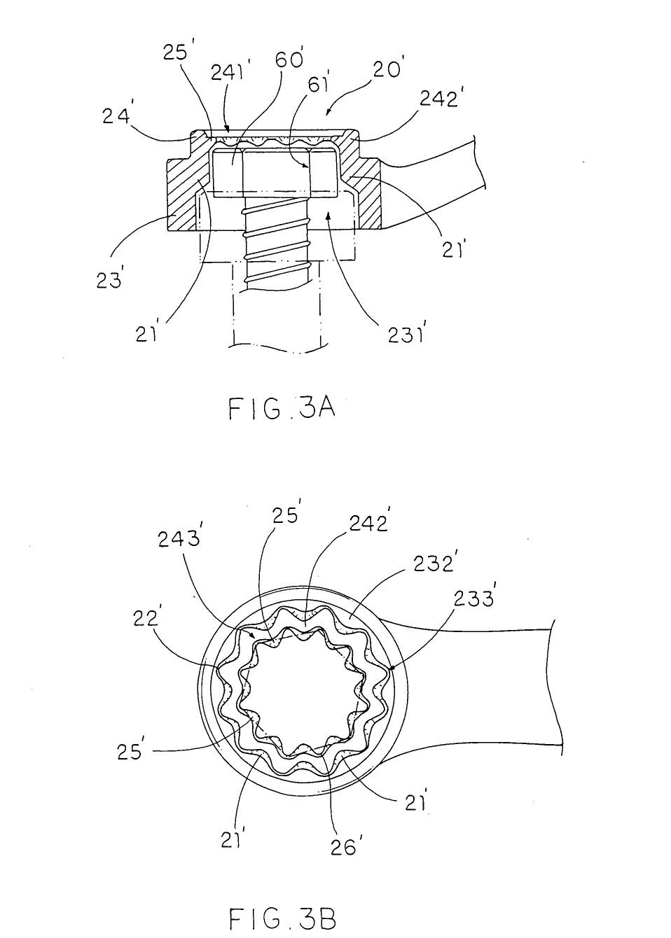

Referring to FIG. 3A and FIG. 3B of the drawings, a first alternative mode of the wrench of the present invention is illustrated, wherein the first alternative mode is similar to the above-mentioned preferred embodiment, except the fact that the end stopper arrangement 20′ further comprises a complementary turning head 24′ provided on top of the turning head 23′, wherein the complementary turning head 24′ is adapted to turn the bolt nut 60′ which has a smaller diameter than that of the turning cavity 231′. In other words, the complementary turning head 24′ provides an extra turning head for the wrench to turn the nut bolt 60′ having the corresponding cross sectional diameter.

According to the first alternative, mode, the complementary turning head 24′ is integrally and upwardly extended from a top side of the turning head 23′ to define a complementary turning cavity 241′, and has a plurality of complementary gripping muscles 242′ spacedly and inwardly protruded from a complementary sidewall 243′ of the complementary turning cavity 241′ for engaging with the corner portions 61′ of the bolt nut 60′.

Moreover, the end stopper arrangement 20′ further comprises a plurality of complementary blocking members 25′ integrally and inwardly protruded from each of the complementary gripping muscles 242′ to partially cover a top opening of the complementary turning cavity 241′ such that when the bolt nut 60′ is inserted into the complementary turning cavity 241′ to engage with the complementary gripping muscles 242′, the complementary blocking members 25′ are adapted for biasing against a top side 63′ of the bolt nut 60′ for ensuring that the bolt nut 60′ is fittedly retained in the complementary turning cavity 235′ without dislodgment of the wrench body 10′.

As in the preferred embodiment of the present invention, the end stopper arrangement 20′ further comprises a plurality of reinforcing ribs 26′ integrally and slightly protruded from the complementary sidewall 243′ of the complementary turning cavity 241′ between each two adjacent complementary gripping muscles 242′ for reinforcing a blocking effect of the complementary blocking members 25′.

As a result, the wrench of the present invention, by the virtue of its turning head 23′ and the complementary turning head 24′, is adapted for turning a nut bolt 60′ of a size corresponding to either the turning cavity 231′ or the complementary turning cavity 241′ by the blocking member 21′ and the complementary blocking member 25′. In other words, the present invention provides a single wrench which fits bolt nuts 60 (60′) of two predetermined differing sizes, wherein the blocking members 21′ (protruded from the gripping muscles 232′ formed on the sidewall 233′) and the reinforcing ribs 22′ of the turning head 23′, and the complementary blocking members 25′ and the complementary reinforcing ribs 26′ of the complementary turning head 24′ are adapted to block the respective bolt nut 60′.

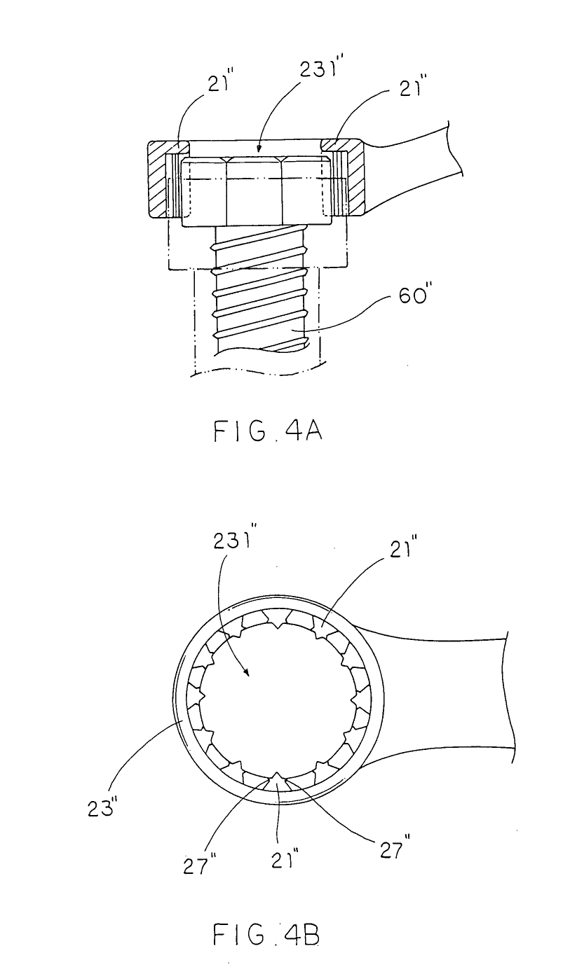

Referring to FIG. 4A and FIG. 4B of the drawings, a second alternative mode of the wrench according to the preferred embodiment of the present invention is illustrated, in which the second alternative mode is similar to the preferred embodiment except that each of the blocking members 21″ has two engagement latches 27″ integrally and sidewardly protruded therefrom within the turning cavity 231″ for engaging with the bolt nut 60 (60′). As a result, the turning head 23″ is adapted to turn bolt nut 60″ with differing sizes.

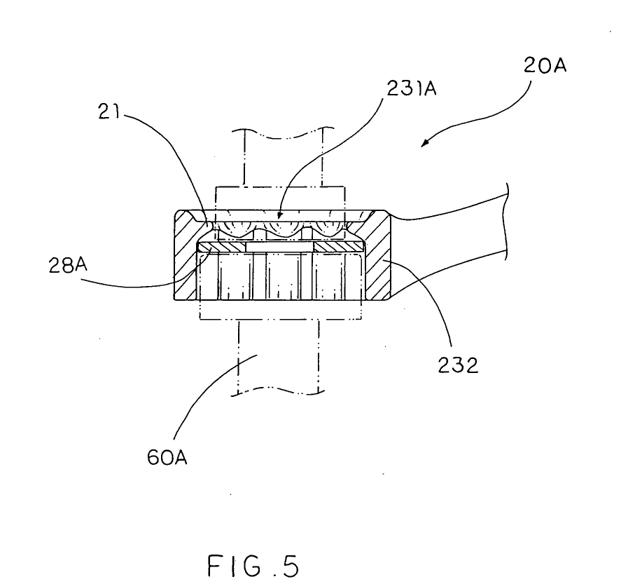

Referring to FIG. 1 and FIG. 5 of the drawings, a third alternative mode of the wrench according to the above preferred embodiment of the present invention is illustrated. The third alternative mode is similar to the preferred embodiment except that the end stopper arrangement 20A further comprises a retention washer 28A securely supported within the turning cavity 231A so as to block an upward movement of the bolt nut 60A when it is engaged with the gripping muscles 232 for being turned. Thus, the retention washer 28A helps in reinforcing a blocking effect of the present invention. Moreover, the wrench may be utilized in its reversed side so that the present invention is capable of turning bolt nut 60A with two differing sizes, while the bolt nut 60A can be blocked by the retention washer 28A.

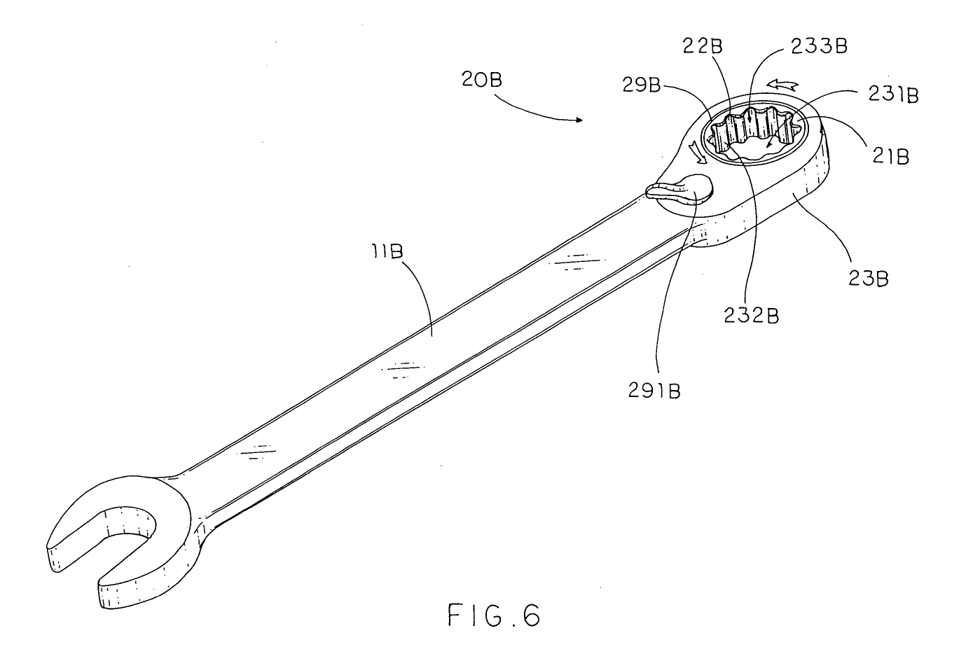

Referring to FIG. 6 of the drawings, a fourth alternative mode of the wrench according to the above preferred embodiment of the present invention is illustrated. The fourth alternative mode is similar to the preferred embodiment except the end stopper arrangement 20B further comprises a wrench rotor 29B rotatably mounted at the turning head 23B to define the turning cavity 231B and the sidewall 233B thereof, wherein the gripping muscles 232B and the reinforcing ribs 22B are integrally protruded from the wrench rotor 29B for engaging with the bolt nut (60) which is inserted into the turning cavity 231B. According to the fourth alternative mode, the wrench rotor 29B is restrained to move only in a single direction, i.e. either clockwise direction or anti-clockwise direction. As shown in FIG. 6 of the drawings, the wrench further comprises a rotation actuator 291B mounted on the turning head 23B to selectively actuate the wrench rotor 29B rotating in a predetermined direction.

Moreover, as shown in FIG. 6 of the drawings, the blocking members 21B are protruded from the gripping muscles 232B for blocking up an upward movement of the bolt nut (60) so as to retain it in position within the turning cavity 231B when the wrench is turning the bolt nut (60).

As a result, the wrench may be utilized in a confined environment where there is insufficient space for turning the handle portion 11B for a whole circular path about the bolt nut (60). For example, when the wrench rotor 29B is only capable of rotating in an anti-clockwise direction and is locked with respect to the clockwise direction, and when it is engaged with the nut bolt (60), the wrench may turn in the anti-clockwise direction for turning the bolt nut (60) for a predetermined distance defined by the circumstances in question. After that, the wrench may then go back along the clockwise direction without turning the bolt nut (60) and then the wrench may complete another round turning in the anti-clockwise fashion as mentioned above. The cycle continues until the nut bolt (60) is fully screwed up or screwed out from a fixture.

From the forgoing descriptions, it can be shown that the above-mentioned objects have been substantially accomplished. The present invention is to provide a wrench comprising the end stopper arrangement 20 which is capable of preventing the wrench from dislodging or slipping during turning of a nut bolt 60.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1-8. (canceled)

9. The wrench, as recited in claim 1, wherein each of said blocking members has two engagement latches integrally and sidewardly protruded therefrom within said turning cavity for fittedly engaging with said bolt nut of differing predetermined sizes.

10. The wrench, as recited in claim 2, wherein each of said blocking members has two engagement latches integrally and sidewardly protruded therefrom within said turning cavity for fittedly engaging with said bolt nut of differing predetermined sizes.

11. The wrench, as recited in claim 3, wherein each of said blocking members has two engagement latches integrally and sidewardly protruded therefrom within said turning cavity for fittedly engaging with said bolt nut of differing predetermined sizes.

12. The wrench, as recited in claim 4, wherein each of said blocking members has two engagement latches integrally and sidewardly protruded therefrom within said turning cavity for fittedly engaging with said bolt nut of differing predetermined sizes.

13. The wrench, as recited in claim 1, wherein said end stopper arrangement further comprises a retention washer securely supported within said turning cavity so as to further enhance a blocking effect to an upward movement of said bolt nut when said bolt nut is engaged with said gripping muscles.

14. The wrench, as recited in claim 2, wherein said end stopper arrangement further comprises a retention washer securely supported within said turning cavity so as to further enhance a blocking effect to an upward movement of said bolt nut when said bolt nut is engaged with said gripping muscles.

15. The wrench, as recited in claim 5, wherein said end stopper arrangement further comprises a retention washer securely supported within said turning cavity so as to further enhance a blocking effect to an upward movement of said bolt nut when said bolt nut is engaged with said gripping muscles.

16. The wrench, as recited in claim 6, wherein said end stopper arrangement further comprises a retention washer securely supported within said turning cavity so as to further enhance a blocking effect to an upward movement of said bolt nut when said bolt nut is engaged with said gripping muscles.

17. The wrench, as recited in claim 1, wherein said end stopper arrangement further comprises a wrench rotor mounted at said turning head in a uni-directionally rotatable manner to form said turning cavity and said sidewall thereof, wherein said gripping muscles are integrally protruded from said wrench rotor for engaging with said bolt nut which is inserted into said turning cavity, while said blocking members are protruded from said gripping muscles for blocking up an upward movement of said bolt nut.

18. The wrench, as recited in claim 2, wherein said end stopper arrangement further comprises a wrench rotor mounted at said turning head in a uni-directionally rotatable manner to form said turning cavity and said sidewall thereof, wherein said gripping muscles are integrally protruded from said wrench rotor for engaging with said bolt nut which is inserted into said turning cavity, while said blocking members are protruded from said gripping muscles for blocking up an upward movement of said bolt nut

19. The wrench, as recited in claim 5, wherein said end stopper arrangement further comprises a wrench rotor mounted at said turning head in a uni-directionally rotatable manner to form said turning cavity and said sidewall thereof, wherein said gripping muscles are integrally protruded from said wrench rotor for engaging with said bolt nut which is inserted into said turning cavity, while said blocking members are protruded from said gripping muscles for blocking up an upward movement of said bolt nut.

20. The wrench, as recited in claim 6, wherein said end stopper arrangement further comprises a wrench rotor mounted at said turning head in a uni-directionally rotatable manner to form said turning cavity and said sidewall thereof, wherein said gripping muscles are integrally protruded from said wrench rotor for engaging with said bolt nut which is inserted into said turning cavity, while said blocking members are protruded from said gripping muscles for blocking up an upward movement of said bolt nut.

21. A wrench for turning a bolt nut having a polygon cross section defining a top side and a plurality of corner portions, comprising:
a wrench body having an elongated handle portion; and
an end stopper arrangement, which comprises:
a turning head, which is integrally extended at said handle portion of said wrench body, having a through turning cavity for said bolt nut receiving therein and a plurality of gripping members spacedly and inwardly protruded from a sidewall of said turning cavity for engaging with said bolt nut at a position that when one of said corner portions of bolt nut is selectively engaged between said two adjacent gripping members, the rest of said corner portions of said bolt nut are alignedly engaged with another said gripping members respectively; and
a plurality of blocking members integrally and inwardly protruded from said gripping members at a position of said sidewall of said turning cavity at an opening thereof, wherein said blocking members are radially and inwardly extended to align with said gripping members respectively in such a manner that when said bolt nut is received in said turning cavity to engage with said gripping members, said blocking members are aligned for biasing against said top side of said bolt nut at said corner portions thereof for ensuring said bolt nut is fittedly retained in said turning cavity to engage with said gripping members without dislodgment of said wrench body.

22. The wrench, as recited in claim 21, wherein said end stopper arrangement further comprises a plurality of reinforcing ribs integrally and slightly protruded between every two of said adjacent gripping members from said sidewall of said turning cavity at a position that each of said reinforcing ribs is formed between every two of said adjacent blocking members such that said reinforcing ribs are adapted for not only enhancing a blocking effect of said bolt nut but also evenly distributing stress along said end stopper arrangement when said bolt nut is driven to be turned by said turning head.

23. The wrench, as recited in claim 21, wherein said end stopper arrangement further comprises a complementary turning head which is integrally extended from a top side of said turning head, and has a through complementary turning cavity and a plurality of complementary gripping members spacedly and inwardly protruded from a complementary sidewall of said complementary turning cavity for engaging with said corner portions of said bolt nut, wherein said complementary turning cavity has a diameter smaller than a diameter of said turning cavity, such that said wrench is adapted to turn said bolt nut having two corresponding diameters which fit one of said turning head and said complementary turning head.

24. The wrench, as recited in claim 22, wherein said end stopper arrangement further comprises a complementary turning head which is integrally extended from a top side of said turning head, and has a through complementary turning cavity and a plurality of complementary gripping members spacedly and inwardly protruded from a complementary sidewall of said complementary turning cavity for engaging with said corner portions of said bolt nut, wherein said complementary turning cavity has a diameter smaller than a diameter of said turning cavity, such that said wrench is adapted to turn said bolt nut having two corresponding diameters which fit one of said turning head and said complementary turning head.

25. The wrench, as recited in claim 23, wherein said end stopper arrangement further comprises a plurality of complementary blocking members integrally and inwardly protruded from said complementary gripping members at said complementary sidewall of said complementary turning cavity to align with said complementary gripping members respectively, such that when said bolt nut is received in said complementary turning cavity to engage with said complementary gripping members, said blocking members are adapted for biasing against said top side of said bolt nut at said corner portions thereof for ensuring that said bolt nut is fittedly retained in said complementary turning cavity without dislodgment of said wrench body.

26. The wrench, as recited in claim 24, wherein said end stopper arrangement further comprises a plurality of complementary blocking members integrally and inwardly protruded from said complementary gripping members at said complementary sidewall of said complementary turning cavity to align with said complementary gripping members respectively, such that when said bolt nut is received in said complementary turning cavity to engage with said complementary gripping members, said blocking members are adapted for biasing against said top side of said bolt nut at said corner portions thereof for ensuring that said bolt nut is fittedly retained in said complementary turning cavity without dislodgment of said wrench body.

27. The wrench, as recited in claim 25, wherein said end stopper arrangement further comprises a plurality of complementary reinforcing ribs integrally and slightly protruded between every two of said complementary gripping members from said complementary sidewall of said complementary turning cavity at a position that each of said complementary reinforcing ribs is formed between every two of said adjacent complementary blocking members such that said complementary reinforcing ribs are adapted for not only enhancing a blocking effect of said bolt nut but also evenly distributing stress along said end stopper arrangement when said bolt nut is driven to be turned by said complementary turning head.

28. The wrench, as recited in claim 26, wherein said end stopper arrangement further comprises a plurality of complementary reinforcing ribs integrally and slightly protruded between every two of said complementary gripping members from said complementary sidewall of said complementary turning cavity at a position that each of said complementary reinforcing ribs is formed between every two of said adjacent complementary blocking members such that said complementary reinforcing ribs are adapted for not only enhancing a blocking effect of said bolt nut but also evenly distributing stress along said end stopper arrangement when said bolt nut is driven to be turned by said complementary turning head.
